(19) United States
(12) Patent Application Publication
(10) Pub. No.: US 2022/0051092 A1
(43) Pub. Date: Feb. 17, 2022

(54) SYSTEM AND METHODS FOR TRANSLATING ERROR MESSAGES

(71) Applicant: Capital One Services, LLC, McLean, VA (US)

(72) Inventors: Austin Walters, Savoy, IL (US); Anh Truong, Champaign, IL (US); Jeremy Edward Goodsitt, Champaign, IL (US)

(21) Appl. No.: 16/993,969

(22) Filed: Aug. 14, 2020

(51) Int. Cl. G06N 3/08; G06N 3/04

(52) U.S. Cl. CPC G06N 3/08; G06N 3/0445; G06N 3/0454

(57) ABSTRACT

The disclosed systems and methods may receive a first stack trace and a first user classification and determine whether the first user classification is an administrator. When the first user classification is not the administrator, the systems and methods may identify and redact, using a first neural network, first sensitive information from the first stack trace to generate a redacted first stack trace, encode, using a second neural network, the redacted first stack trace to generate a first embedding, decode, using a third neural network, the first embedding to generate a first text explanation corresponding to the redacted first stack trace, decode, using a fourth neural network, the first embedding to generate a second stack trace corresponding to the redacted first stack trace, and transmit, to a first user device for display, the first text explanation and the second stack trace.

### FIELD OF INVENTION

The present disclosure relates to translating a stack trace and optionally redacting or tokenizing sensitive information found within the stack trace.

### BACKGROUND

Error messages or stack traces received from a software application (e.g., an application built by web-based software such as Ruby on Rails, Sinatra, Flask, or WordPress) are commonly difficult to decipher leaving a user unable to determine how to debug the software application. In order to decipher the received stack traces, the user must consult a dictionary or manual to understand the problem the stack trace is trying to convey. This process is very time consuming and costly.

Additionally, stack traces often contain sensitive information (e.g., personal identifiable information (PII), proprietary business information, privileged information, or health information) that is inappropriate, risky, or illegal to provide to an ordinary user. However, an administrator may need that information to fully understand a problem.

Accordingly, there is a need for improved systems and methods to translate stack traces to text explanations while keeping sensitive information private to ordinary users. Embodiments of the present disclosure are directed to this and other considerations.

### SUMMARY

Disclosed embodiments provide systems and methods translating a stack trace and optionally redacting or tokenizing sensitive information found within the stack trace.

The system may include one or more processors and a memory in communication with the one or more processors and storing instructions that when executed by the one or more processors, are configured to cause the system to perform steps of a method. The method may include receiving training data including a first stack trace, a first embedding of the first stack trace, a first text explanation corresponding to the first stack trace, a redacted first stack trace, a first embedding of the redacted first stack trace, a first redacted text explanation corresponding to the redacted first stack trace, and a first user classification (e.g., “general user” or “administrator”). The method may include training a first neural network to identify and redact first sensitive information from the first stack trace to generate the redacted first stack trace depending on the first user classification (e.g., “general user” or “administrator”) by providing the first neural network with the first stack trace, the redacted first stack trace, and the first user classification. The method may include training a second neural network (e.g., an autoencoder) to encode the first stack trace or the redacted first stack trace depending on the first user classification (e.g., “general user” or “administrator”) by providing the second neural network with the redacted first stack trace, the first stack trace, the first embedding of the first stack trace, and the first embedding of the redacted first stack trace. The method may include training a third neural network (e.g., an autoencoder) to decode the first embedding of the first stack trace or the first embedding of the redacted first stack trace into the first text explanation corresponding to the first stack trace or the first redacted text explanation corresponding to the redacted first stack trace depending on the first user classification (e.g., “general user” or “administrator”) by providing the third neural network with the first embedding of the first stack trace, the first embedding of the redacted first stack trace, the first text explanation corresponding to the first stack trace, and the first text explanation corresponding to the redacted first stack trace. The method may include training a fourth neural network (e.g., an autoencoder) to decode the first embedding of the first stack trace or the first embedding of the redacted first stack trace to generate a new first stack trace corresponding to the first stack trace or a new redacted first stack trace corresponding to the first redacted stack trace depending on the first user classification (e.g., “general user” or “administrator”) by providing the fourth neural network with the first embedding of the redacted first stack trace, the first embedding of the first stack trace the redacted first stack trace, and the first stack trace.

The method may also include receiving a second stack trace and a second user classification (e.g., “general user” or “administrator”), determining whether the second user classification (e.g., “general user” or “administrator”) corresponds to an administrator. When the second user classification (e.g., “general user” or “administrator”) does not correspond to the administrator, the method may also include identifying and redacting, using the first neural network, second sensitive information (e.g., PII) from the second stack trace to generate a redacted second stack trace, encoding, using the second neural network, the redacted second stack trace to generate a second embedding, decoding, using the third neural network, the second embedding to generate a second text explanation corresponding to the redacted second stack trace, decoding, using the fourth neural network, the second embedding to generate a third stack trace corresponding to the redacted second stack trace, and transmitting, to a first user device for display, the second text explanation and the third stack trace.

The system may include one or more processors and a memory in communication with the one or more processors and storing instructions that when executed by the one or more processors, are configured to cause the system to perform steps of a method. The method may include receiving a first stack trace and a first user classification (e.g., “general user” or “administrator”) and determining whether the first user classification is an administrator. When the first user classification (e.g., “general user” or “administrator”) is not the administrator, the method may also include identifying and redacting, using a first neural network, first sensitive information from the first stack trace to generate a redacted first stack trace, encoding, using a second neural network (e.g., an autoencoder), the redacted first stack trace to generate a first embedding, decoding, using a third neural network (e.g., an autoencoder), the first embedding to generate a first text explanation corresponding to the redacted first stack trace, decoding, using a fourth neural network (e.g., an autoencoder), the first embedding to generate a second stack trace corresponding to the redacted first stack trace, and transmitting, to a first user device for display, the first text explanation and the second stack trace.

The system may include one or more processors and a memory in communication with the one or more processors and storing instructions that when executed by the one or more processors, are configured to cause the system to perform steps of a method. The method may include receiving a first stack trace and a first user classification (e.g., “general user” or “administrator”) associated with a first user of a first user device. The method may include identifying, by a first neural network, sensitive information in the first stack trace, tokenizing, by the first neural network, the sensitive information in the first stack trace to generate a tokenized first stack trace. The method may include encoding, using a second neural network (e.g., an autoencoder), the tokenized first stack trace to generate a first embedding. The method may include decoding, using a third neural network, (e.g., an autoencoder) the first embedding to generate a tokenized first text explanation corresponding to the tokenized first stack trace. The method may include decoding, using a fourth neural network (e.g., an autoencoder), the first embedding to generate a tokenized second stack trace corresponding to the tokenized first stack trace. The method may include determining whether the first user classification (e.g., “general user” or “administrator”) corresponds to an administrator. When the first user classification (e.g., “general user” or “administrator”) corresponds to the administrator, the method may include detokenizing the tokenized second stack trace to generate a third stack trace, detokenizing the tokenized first text explanation to generate a second text explanation, and transmitting, to the first user device for display, the third stack trace and the second text explanation.

Further features of the disclosed systems, and the advantages offered thereby, are explained in greater detail hereinafter with reference to specific embodiments illustrated in the accompanying drawings, wherein like elements are indicated be like reference designators.

### BRIEF DESCRIPTION OF THE DRAWINGS

Reference will now be made to the accompanying drawings, which are not necessarily drawn to scale, and which are incorporated into and constitute a portion of this disclosure, illustrate various implementations and aspects of the disclosed technology and, together with the description, serve to explain the principles of the disclosed technology. In the drawings:

FIG. 1A, FIG. 1B, and FIG. 1C are flowcharts of an exemplary method for training and processing first stack traces to redact sensitive information from the stack traces based on a user classification and translate the (redacted) stack traces into text explanations;

FIG. 2A and FIG. 2B are flowcharts of another exemplary method for generating a text explanation from a stack trace and redacting the stack trace depending on whether the requesting user is an administrator;

FIG. 3 is a flowchart of a further exemplary method for generating a text explanation from a tokenized stack trace and detokenizing the stack trace depending on whether the requesting user is an administrator;

FIG. 4 is a flowchart of another exemplary method for generating a text explanation from a received redacted stack trace;

FIG. 5 is a flowchart of a further exemplary method for generating a text explanation from a stack trace;

FIG. 6 is a component diagram of an example error message translation system; and

FIG. 7 is a diagram of an exemplary system for to translating a stack trace and optionally redacting or tokenizing sensitive information found within the stack trace.

### DETAILED DESCRIPTION

Some implementations of the disclosed technology will be described more fully with reference to the accompanying drawings. This disclosed technology may, however, be embodied in many different forms and should not be construed as limited to the implementations set forth herein. The components described hereinafter as making up various elements of the disclosed technology are intended to be illustrative and not restrictive. Many suitable components that would perform the same or similar functions as components described herein are intended to be embraced within the scope of the disclosed electronic devices and methods. Such other components not described herein may include, but are not limited to, for example, components developed after development of the disclosed technology.

It is also to be understood that the mention of one or more method steps does not preclude the presence of additional method steps or intervening method steps between those steps expressly identified. Similarly, it is also to be understood that the mention of one or more components in a device or system does not preclude the presence of additional components or intervening components between those components expressly identified.

Reference will now be made in detail to exemplary embodiments of the disclosed technology, examples of which are illustrated in the accompanying drawings and disclosed herein. Wherever convenient, the same references numbers will be used throughout the drawings to refer to the same or like parts.

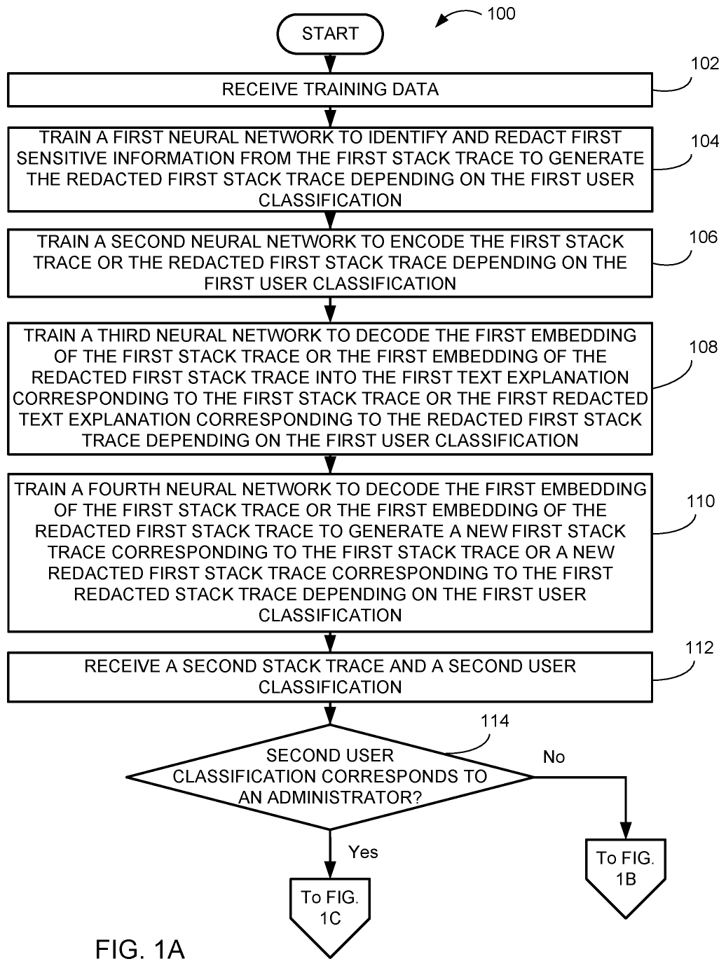

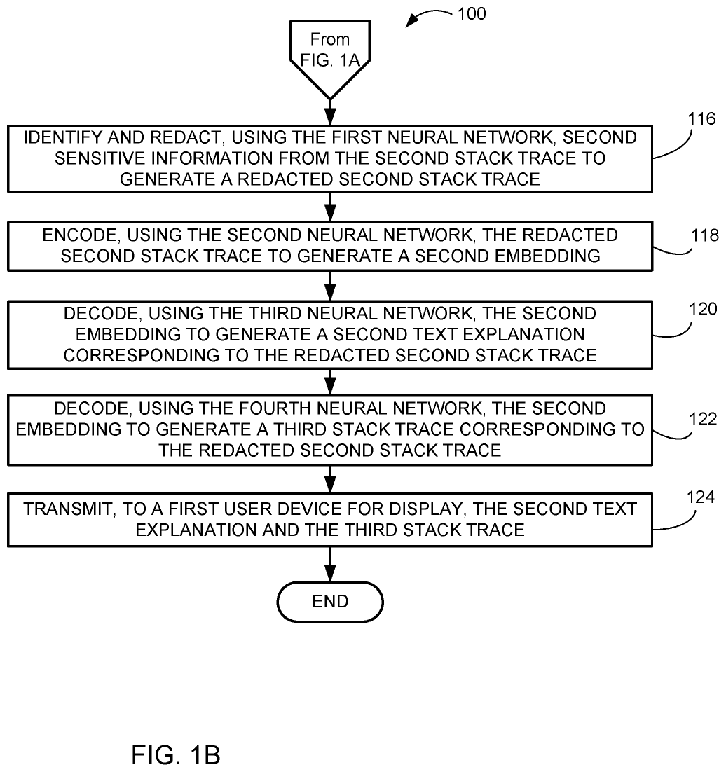

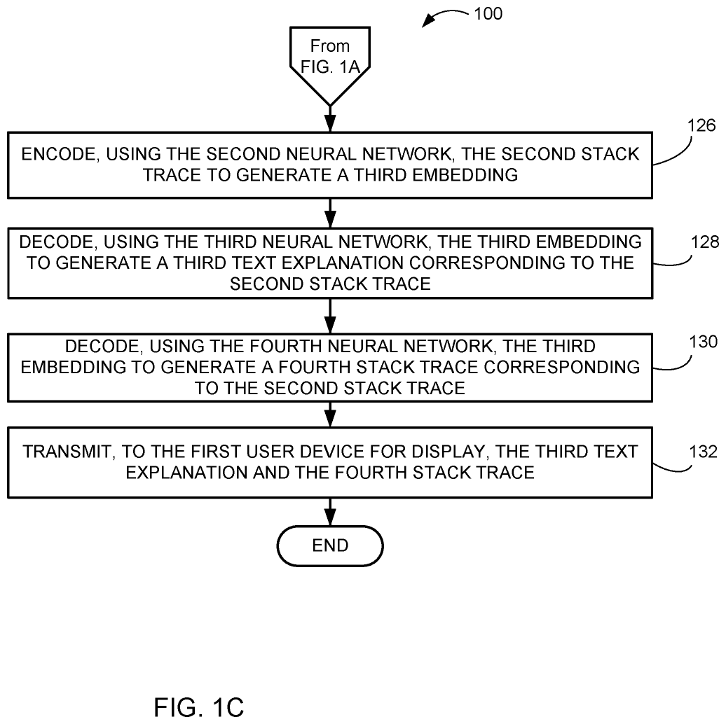

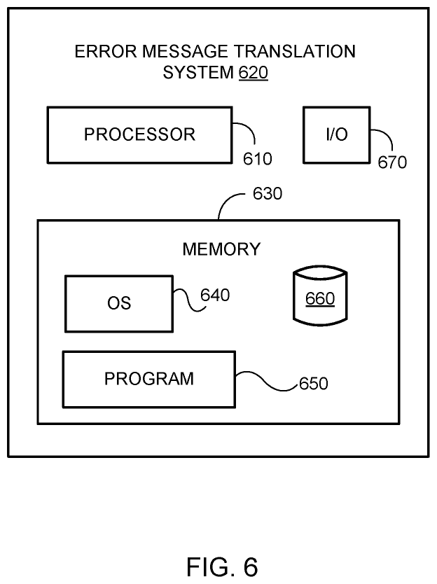

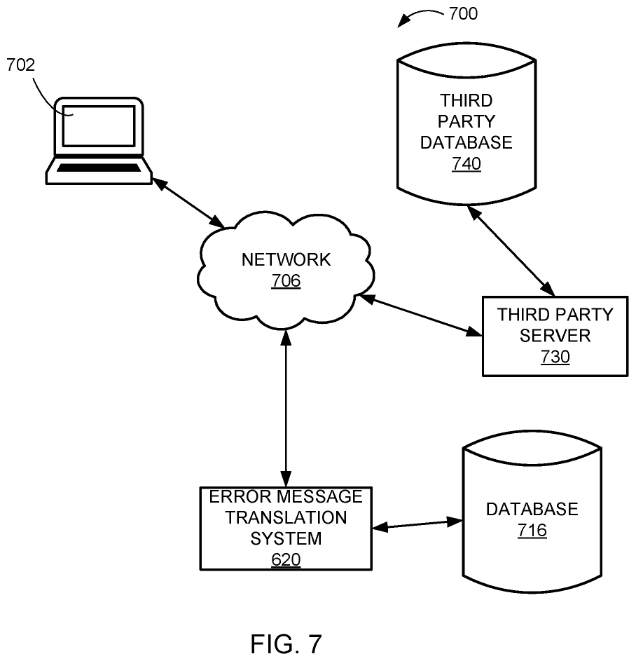

FIG. 1A, FIG. 1B, and FIG. 1C are flowcharts of an exemplary method 100 for training and processing first stack traces to redact sensitive information from the stack traces based on a user classification and translate the (redacted) stack traces into text explanations. Method 100 may be performed by a system (e.g., an error message translation system 620 and/or some or all of the devices and systems within a system 700 described in more detail with respect to FIGS. 6 and 7 below).

In block 102, the error message translation system 620 may receive training data (training data set) including a first stack trace, a first embedding of the first stack trace, a first text explanation (or human readable explanation) corresponding to the first stack trace, a redacted first stack trace (which is redacted ahead of time to remove sensitive information by, for example, name entity recognition (NER) systems), a first embedding of the redacted first stack trace, a first redacted text explanation (or human readable explanation) corresponding to the redacted first stack trace, and a first user classification. The first stack trace may be a report of active stack frames at a given time during the execution of an application and may be from a first error log. Programmers may use a stack trace to debug an application. Below is an example of a simple stack trace that the system may receive:
>>>import nltk
Traceback (most recent call last):
   File “<stdin>”, line 1, in <module>
ModuleNotFoundError: No module named ‘nltk’
   In addition, the system may receive the following corresponding text explanation:
“NLTK library not installed in Python3, recommend installing to use”

Although the error message translation system 620 is described as receiving the above described training data, the above described training data may be only one data set of many data sets used to train a first neural network, a second neural network, a third neural network, and a fourth neural network described below. Each of the additional data sets may include the same types of data as the training data set described above. Thus, the error message translation system 620 may receive a plurality of training data sets each including a stack trace, a embedding of the first stack trace, a text explanation corresponding to the stack trace, a redacted stack trace, a embedding of the redacted stack trace, a redacted text explanation corresponding to the redacted stack trace, and a user classification.

In block 104, the error message translation system 620 may train a first neural network (e.g., a name entity recognition (NER) system) to identify and redact first sensitive information from the first stack trace to generate the redacted first stack trace depending on the first user classification by providing the first neural network with the first stack trace, the redacted first stack trace, and the first user classification. The first neural network may be an autoencoder, a generative adversarial network (GAN), a recurrent neural network (RNN), a non-recurrent neural network (NRNN), a convolutional neural network (CNN), a name entity recognition (NER) system, or a combination thereof. The first neural network may include long short-term memory (LSTM) or gated recurrent units (GAUs), or both. The error message translation system 620 may train a NER system (e.g., Amazon Macie) to identify the first sensitive information from the first stack trace by providing the NER system with the first stack trace along with (manually) labeled data (e.g., a label of “credit card number” next to the credit card number) from the first stack trace.

Each user that is able to access a particular application (e.g., an application on Ruby on Rails, Sinatra, Flask, or WordPress) that is generating a stack trace received by the error message translation system 620 may be given a user classification upon registration with that application. The assigned user classification may be of various levels. For example, the assigned user classification may be a general user, an editor, an administrator, or some other user classification. For example, the general user classification may be “user” or “general user” and the administrator may be “administrator.” Thus, the first user classification that is a part of the training data may correspond to a general user, an editor, an administrator, or some other user classification.

The error message translation system 620 may also train the first neural network or a neural network separate from the first neural network to determine whether the first user classification is the administrator by providing the first neural network with the first user classification and an administrator classification and a general user classification. The first neural network is trained to identify that the first user classification matches the general user classification and does not match the administrator classification. In some embodiments, an editor or other user may be allowed to view the sensitive information in the stack trace. In such a case, the error message translation system 620 may also train the first neural network or a separate neural network to determine whether the first user classification is the administrator, the editor, or other user able to view sensitive information. The separate neural network may be an autoencoder, a generative adversarial network (GAN), a recurrent neural network (RNN), a non-recurrent neural network (NRNN), a convolutional neural network (CNN), a name entity recognition (NER) system, or a combination thereof.

In block 106, the error message translation system 620 may train a second neural network to encode the first stack trace or the redacted first stack trace depending on the first user classification by providing the second neural network with the redacted first stack trace, the first stack trace, the first embedding of the first stack trace, and the first embedding of the redacted first stack trace. The second neural network may be an autoencoder, a generative adversarial network (GAN), a recurrent neural network (RNN), a non-recurrent neural network (NRNN), a convolutional neural network (CNN), or a combination thereof.

In block 108, the error message translation system 620 may train a third neural network to decode the first embedding of the first stack trace or the first embedding of the redacted first stack trace into the first text explanation corresponding to the first stack trace or the first redacted text explanation corresponding to the redacted first stack trace depending on the first user classification by providing the third neural network with the first embedding of the first stack trace, the first embedding of the redacted first stack trace, the first text explanation corresponding to the first stack trace, and the first text explanation corresponding to the redacted first stack trace. The third neural network may be an autoencoder, a generative adversarial network (GAN), a recurrent neural network (RNN), a non-recurrent neural network (NRNN), a convolutional neural network (CNN), or a combination thereof.

In block 110 the error message translation system 620 may train a fourth neural network to decode the first embedding of the first stack trace or the first embedding of the redacted first stack trace to generate a new first stack trace corresponding to the first stack trace or a new redacted first stack trace corresponding to the first redacted stack trace depending on the first user classification by providing the fourth neural network with the first embedding of the redacted first stack trace, the first embedding of the first stack trace the redacted first stack trace, and the first stack trace. The fourth neural network may be an autoencoder, a generative adversarial network (GAN), a recurrent neural network (RNN), a non-recurrent neural network (NRNN), a convolutional neural network (CNN), or a combination thereof.

In block 112, the error message translation system 620 may receive a second stack trace and a second user classification. The second stack trace and the second user classification may be received from user device 702 or third party server 730. The second stack trace may be from a second error log. In some embodiments, the second stack trace can be a combined stack trace from more than one source. For example, if a smart phone (e.g., an iPhone) was unable to sync with cloud storage (e.g., iCloud) because one of an internet provider's (e.g., Verizon's) internet nodes lost power, the smart phone would record an error as a stack trace and Verizon would also record an error as a stack trace. Both stack traces may be provided to the error message translation system 620 system, which may combine them because the error message translation system 620 may recognize that they correspond to the same event based on timestamps, location data, and other context data.

In block 114, the error message translation system 620 may determine whether the second user classification corresponds to an administrator. When the second user classification does not correspond to the administrator, proceed to blocks 116, 118, 120, 122, and 124. When the second user classification corresponds to the administrator proceed to blocks 126, 128, 130, and 132. In some embodiments, the error message translation system 620 may use the first neural network to determine whether the second user classification corresponds to the administrator (e.g., an administrator classification).

In block 116, the error message translation system 620 may identify and redact, using the first neural network or a name entity recognition system (NER), second sensitive information from the second stack trace to generate a redacted second stack trace. In some embodiments, the error message translation system 620 may instruct or enlist the name entity recognition (NER) system (e.g., Amazon Macie) to identify the second sensitive information form the second stack trace by providing the NER System with the second stack trace.

In block 118, the error message translation system 620 may encode, using the second neural network, the redacted second stack trace to generate a second embedding. The second embedding is a low dimensional learned vector representation of the redacted second stack trace that allows provides a better input to a machine learning model (e.g., the third neural network and the fourth neural network) than the raw data. Essentially, it is a translation to a machine learning language that allows for it to be easily analyzed by a machine learning model.

In block 120, the error message translation system 620 may decode, using the third neural network, the second embedding to generate a second text explanation corresponding to the redacted second stack trace. In an embodiment, when the stack trace is a combination of stack traces form different sources, the error message translation system 620 may create the text explanation that takes into account multiple error locations allowing the end user to know which systems/locations are impacted by an error.

In block 122, the error message translation system 620 may decode, using the fourth neural network, the second embedding to generate a third stack trace corresponding to the redacted second stack trace. The third stack trace would be similar if not the same as the redacted second stack trace.

In block 124, the error message translation system 620 may transmit, to a first user device for display, the second text explanation and the third stack trace. Once the first user device receives the second text explanation and the third stack trace, a first user of the first user device can begin to debug the application without reading sensitive information.

In block 126, the error message translation system 620 may encode, using the second neural network, the second stack trace to generate a third embedding.

In block 128, the error message translation system 620 may decode, using the third neural network, the third embedding to generate a third text explanation corresponding to the second stack trace.

In block 130, the error message translation system 620 may decode, using the fourth neural network, the third embedding to generate a fourth stack trace corresponding to the second stack trace.

In block 132, the error message translation system 620 may transmit, to the first user device for display, the third text explanation and the fourth stack trace. Once the first user device receives the second text explanation and the third stack trace, a first user of the first user device can begin to debug the application while being able to read the entire stack trace including sensitive information found therein.

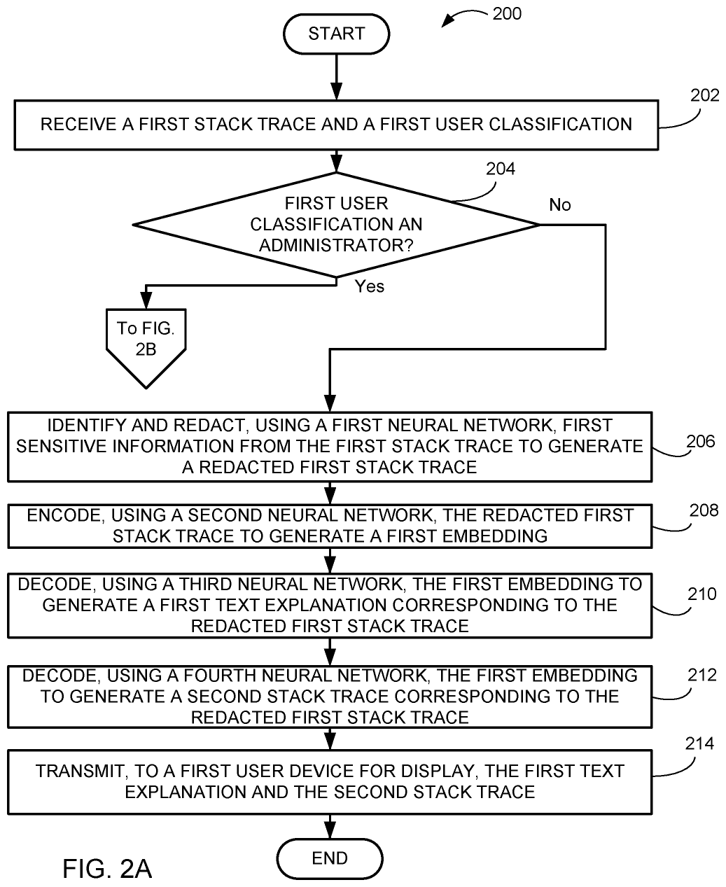

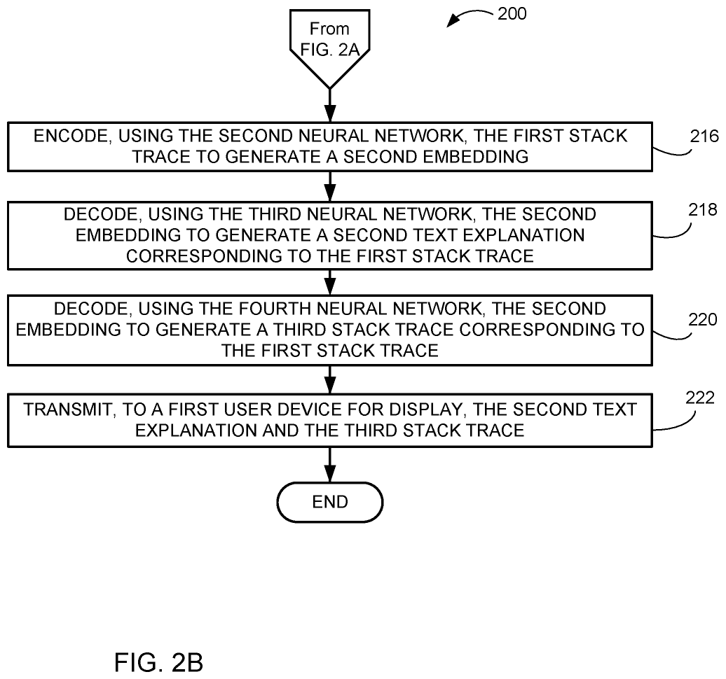

FIG. 2A and FIG. 2B are flowcharts of another exemplary method 200 for generating a text explanation from a stack trace and redacting the stack trace depending on whether the requesting user is an administrator. Method 200 may be performed by a system (e.g., an error message translation system 620 and/or some or all of the devices and systems within a system 700 described in more detail with respect to FIGS. 6 and 7 below).

In block 202, the error message translation system 620 may receive a first stack trace and a first user classification.

In block 204, the error message translation system 620 may determine whether the first user classification is an administrator. When the first user classification is not an administrator, proceed to blocks 204, 206, 208, 210, and 212. When the first user classification is the administrator, proceed to blocks 214, 216, 218, and 220. In some embodiments, the first neural network may determine whether the first user classification is the administrator (e.g., administrator classification rather than a general user classification).

In block 206, the error message translation system 620 may identify and redact, using a first neural network, first sensitive information from the first stack trace to generate a redacted first stack trace. The first neural network may include an autoencoder, a generative adversarial network, a recurrent neural network, a non-recurrent neural network, a convolutional neural network, or a combination thereof. The first neural network may include long short-term memory, gated recurrent units, or both

In block 208, the error message translation system 620 may encode, using a second neural network, the redacted first stack trace to generate a first embedding. The second neural network may include an autoencoder, a generative adversarial network, a recurrent neural network, a non-recurrent neural network, a convolutional neural network, or a combination thereof. The second neural network may include long short-term memory, gated recurrent units, or both

In block 210, the error message translation system 620 may decode, using a third neural network, the first embedding to generate a first text explanation corresponding to the redacted first stack trace. The third neural network may include an autoencoder, a generative adversarial network, a recurrent neural network, a non-recurrent neural network, a convolutional neural network, or a combination thereof. The third neural network may include long short-term memory, gated recurrent units, or both

In block 212, the error message translation system 620 may decode, using a fourth neural network, the first embedding to generate a second stack trace corresponding to the redacted first stack trace. The fourth neural network may include an autoencoder, a generative adversarial network, a recurrent neural network, a non-recurrent neural network, a convolutional neural network, or a combination thereof. The fourth neural network may include long short-term memory, gated recurrent units, or both

In block 214, the error message translation system 620 may transmit, to a first user device for display, the first text explanation and the second stack trace.

In block 216, the error message translation system 620 may encode, using the second neural network, the first stack trace to generate a second embedding.

In block 218, the error message translation system 620 may decode, using the third neural network, the second embedding to generate a second text explanation corresponding to the first stack trace.

In block 220, the error message translation system 620 may decode, using the fourth neural network, the second embedding to generate a third stack trace corresponding to the first stack trace. In some embodiments, the error message translation system 620 omits block 220.

In block 222, the error message translation system 620 may transmit, to a first user device for display, the second text explanation and the third stack trace. In some embodiments where block 220 is omitted, the error message translation system 620 may transmit, to the first use device for display, the second text explanation and the redacted first stack trace.

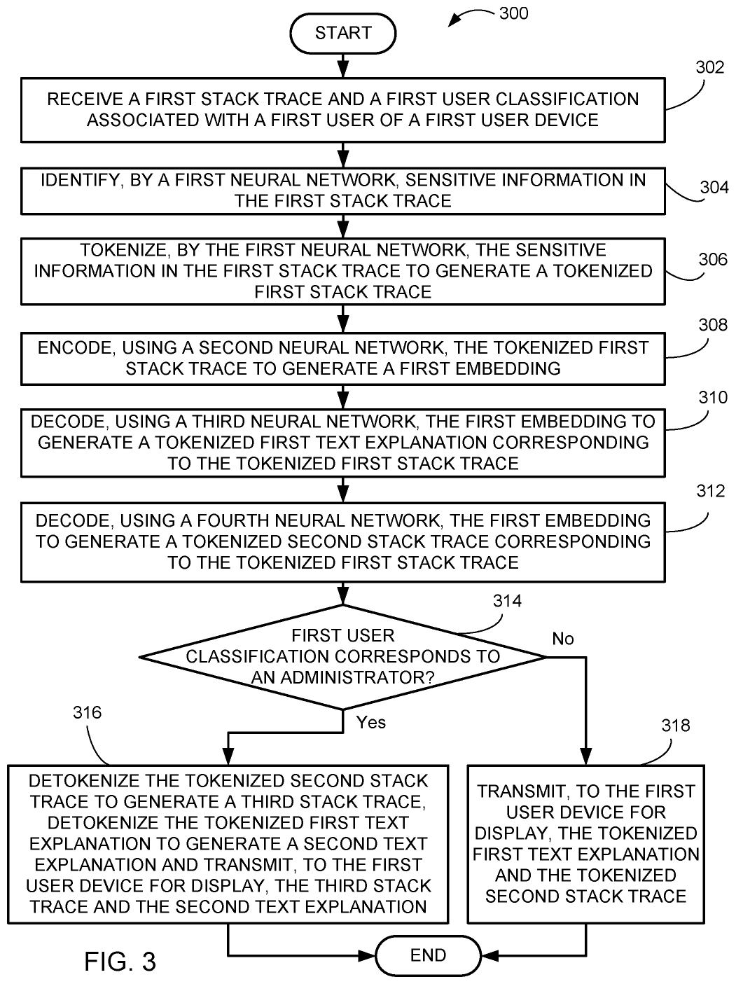

FIG. 3 is a flowchart of a further exemplary method 300 for generating a text explanation from a tokenized stack trace and detokenizing the stack trace depending on whether the requesting user is an administrator. Method 300 may be performed by a system (e.g., an error message translation system 620 and/or some or all of the devices and systems within a system 700 described in more detail with respect to FIGS. 6 and 7 below).

In block 302, the error message translation system 620 may receive a first stack trace and a first user classification associated with a first user of a first user device.

In block 304, the error message translation system 620 may identify, by a first neural network, sensitive information in the first stack trace. The first neural network may include an autoencoder, a generative adversarial network, a recurrent neural network, a non-recurrent neural network, a convolutional neural network, or a combination thereof.

In block 306, the error message translation system 620 may tokenize, by the first neural network, the sensitive information in the first stack trace to generate a tokenized first stack trace.

In block 308, the error message translation system 620 may encode, using a second neural network, the tokenized first stack trace to generate a first embedding. The second neural network may include an autoencoder, a generative adversarial network, a recurrent neural network, a non-recurrent neural network, a convolutional neural network, or a combination thereof. By identifying and tokenizing the sensitive information (e.g., a credit card number) before encoding, the second neural network requires fewer (hundreds to thousands versus millions) examples of training data (e.g., credit card numbers) to generate the first embedding with the credit card number than the non-tokenized version containing the actual sensitive information. By tokenizing first, the NER system can all but guarantee that the sensitive information is not leaked.

In block 310, the error message translation system 620 may decode, using a third neural network, the first embedding to generate a tokenized first text explanation corresponding to the tokenized first stack trace. The third neural network may include an autoencoder, a generative adversarial network, a recurrent neural network, a non-recurrent neural network, a convolutional neural network, or a combination thereof.

In block 312, the error message translation system 620 may decode, using a fourth neural network, the first embedding to generate a tokenized second stack trace corresponding to the tokenized first stack trace. The fourth neural network may include an autoencoder, a generative adversarial network, a recurrent neural network, a non-recurrent neural network, a convolutional neural network, or a combination thereof. In some embodiments, the error message translation system 620 may omit block 312.

In block 314, the error message translation system 620 may determine whether the first user classification corresponds to an administrator. When the first user classification corresponds to an administrator, proceed to block 316. When the first user classification does not correspond to an administrator, proceed to block 318.

In block 316, the error message translation system 620 may detokenize the tokenized second stack trace to generate a third stack trace, detokenize the tokenized first text explanation to generate a second text explanation and transmit, to the first user device for display, the third stack trace and the second text explanation. In some embodiments when block 312 is omitted, the error message translation system 620 may detokenize the first text explanation to generate a second text explanation and transmit the first stack trace and the first text explanation to the first user device for display.

In block 318, the error message translation system 620 may transmit, to the first user device for display, the tokenized first text explanation and the tokenized second stack trace. In some embodiments when block 312 is omitted, the error message translation system 620 may transmit the tokenized first text explanation and the tokenized first stack trace.

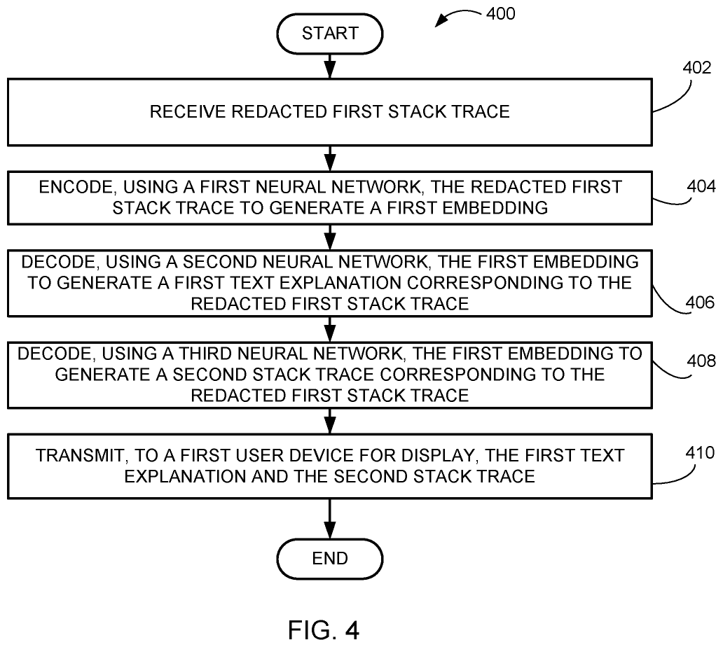

FIG. 4 is a flowchart of another exemplary method 400 for generating a text explanation from a received redacted stack trace. Method 400 may be performed by a system (e.g., an error message translation system 620 and/or some or all of the devices and systems within a system 700 described in more detail with respect to FIGS. 6 and 7 below).

Method 400 contains similar steps to method 200. For example, steps 404, 406, 408, and 410 of method 400 are respectively similar to steps 208, 210, 212, and 214 of method 400. The descriptions of 404, 406, 408, and 410 will not be described below for brevity but respectively incorporate the descriptions above of steps 208, 210, 212, and 214 from method 400. However, method 400 contains a different step 402 (described below) which replaces steps 202, 204, and 206 of method 200.

In block 402, the error message translation system 620 may receive redacted first stack trace. The redacted first stack trace may be received from user device 702 or third party server 730. The second stack trace may from a second error log.

In other embodiments, at least the second neural network, the third neural network, and the fourth neural network described above with respect to methods 100, 200, 300, and 400 may be decoders that are specifically trained for a particular user classification (e.g., administrator, general user, editor, programmer, etc.). In one example, an editor may be allowed to view the sensitive information in the stack trace as well as an administrator. In such a case, the error message translation system 620 may train the first neural network to determine whether the first user classification is the administrator, the editor, or other user able to view sensitive information. In some cases, there may be certain levels of sensitive information (social security numbers being some of the most sensitive and credit card numbers being moderately sensitive) and only certain user classifications that can view certain information. For example, an administrator may be able to see all sensitive information (e.g., social security numbers and credit card numbers), a programmer may only be able to see some of the sensitive information (e.g., credit card numbers), and a general user may not be able to see any of the sensitive information. In such a case, the decoders may be trained to decode the embedding described above for the appropriate user based on the upfront determination of which user is requesting the stack trace.

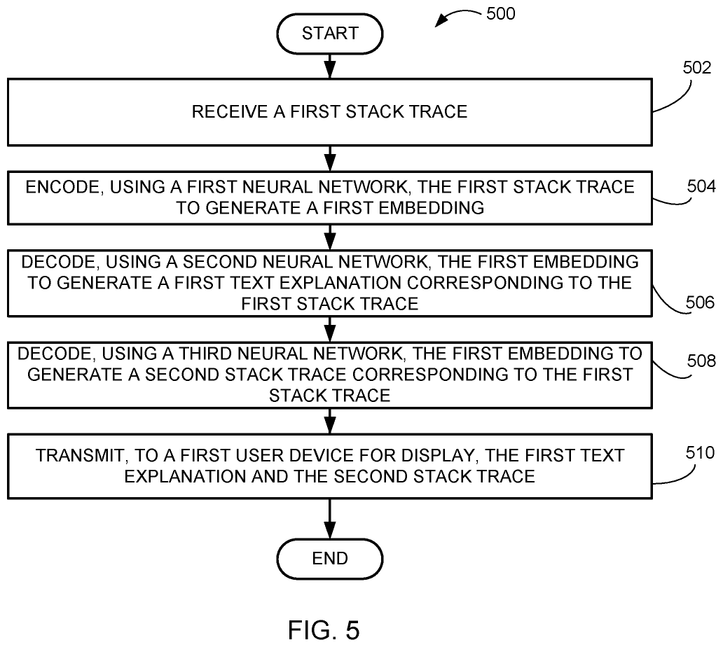

FIG. 5 is a flowchart of a further exemplary method for generating a text explanation from a stack trace. Method 500 may be performed by a system (e.g., an error message translation system 620 and/or some or all of the devices and systems within a system 700 described in more detail with respect to FIGS. 6 and 7 below).

Method 500 contains similar steps to method 400. For example, steps 502, 504, 506, 508, and 510 of method 500 are respectively similar to steps 402, 404, 406, 408, and 410 of method 400. The descriptions of 502, 504, 506, 508, and 510 will not be described below for brevity, but respectively incorporate the descriptions above of steps 402, 404, 406, 408, and 410 of method 400 and the descriptions of 208, 210, 212, and 214 from method 400 incorporated for 404, 406, 408, and 410 of method 400. However, method 500 involves receiving (step 502), encoding (step 504), and decoding (steps 506 and 508) a first stack trace that is not redacted rather than receiving a redacted stack trace (step 402). Also, method 500 involves transmitting the first text explanation and the second tract trace (corresponding to the unredacted first stack trace) to a first user device (step 510).

FIG. 6 is a component diagram of an example of the error message translation system 620 that may be used to generate a merchant trust score and generate and send a payment recommendation (e.g., a temporary credit card number) to a user device for use.

As shown, error message translation system 620 may include a processor 610, an input/output (“I/O”) device 670, a memory 630 containing an operating system (“OS”) 640 and a program 650. For example, error message translation system 620 may be a single device or server or may be configured as a distributed computer system including multiple servers, devices, or computers that interoperate to perform one or more of the processes and functionalities associated with the disclosed embodiments. In some embodiments, error message translation system 620 may further include a peripheral interface, a transceiver, a mobile network interface in communication with the processor 610, a bus configured to facilitate communication between the various components of error message translation system 620, and a power source configured to power one or more components of error message translation system 620.

A peripheral interface (not shown) may include hardware, firmware and/or software that enables communication with various peripheral devices, such as media drives (e.g., magnetic disk, solid state, or optical disk drives), other processing devices, or any other input source used in connection with the instant techniques. In some embodiments, a peripheral interface may include a serial port, a parallel port, a general purpose input and output (GPIO) port, a game port, a universal serial bus (USB), a micro-USB port, a high definition multimedia (HDMI) port, a video port, an audio port, a Bluetooth™ port, a near-field communication (NFC) port, another like communication interface, or any combination thereof.

In some embodiments, a transceiver (not shown) may be configured to communicate with compatible devices and ID tags when they are within a predetermined range. A transceiver may be compatible with one or more of: radio-frequency identification (RFID), near-field communication (NFC), Bluetooth™, low-energy Bluetooth™ (BLE), WiFi™, ZigBee™, ambient backscatter communications (ABC) protocols or similar technologies.

A mobile network interface (not shown) may provide access to a cellular network, the Internet, a local area network, or another wide-area network. In some embodiments, a mobile network interface may include hardware, firmware, and/or software that allows the processor(s) 610 to communicate with other devices via wired or wireless networks, whether local or wide area, private or public, as known in the art. A power source may be configured to provide an appropriate alternating current (AC) or direct current (DC) to components requiring power.

Processor 610 may include one or more of a microprocessor, microcontroller, digital signal processor, co-processor or the like or combinations thereof capable of executing stored instructions and operating upon stored data. Memory 430 may include, in some implementations, one or more suitable types of memory (e.g. such as volatile or non-volatile memory, random access memory (RAM), read only memory (ROM), programmable read-only memory (PROM), erasable programmable read-only memory (EPROM), electrically erasable programmable read-only memory (EEPROM), magnetic disks, optical disks, floppy disks, hard disks, removable cartridges, flash memory, a redundant array of independent disks (RAID), and the like), for storing files including an operating system, application programs (including, for example, a web browser application, a widget or gadget engine, and or other applications, as necessary), executable instructions and data. In one embodiment, the processing techniques described herein are implemented as a combination of executable instructions and data within the memory 630.

Processor 610 may be one or more known processing devices, such as a microprocessor from the Pentium™ family manufactured by Intel™ or the Turion™ family manufactured by AMD™. Processor 610 may constitute a single core or multiple core processor that executes parallel processes simultaneously. For example, processor 610 may be a single core processor that is configured with virtual processing technologies. In certain embodiments, processor 610 may use logical processors to simultaneously execute and control multiple processes. Processor 610 may implement virtual machine technologies, or other similar known technologies to provide the ability to execute, control, run, manipulate, store, etc. multiple software processes, applications, programs, etc. One of ordinary skill in the art would understand that other types of processor arrangements could be implemented that provide for the capabilities disclosed herein.

Error message translation system 620 may include one or more storage devices configured to store information used by processor 610 (or other components) to perform certain functions related to the disclosed embodiments. In some embodiments, error message translation system 620 may include memory 630 that includes instructions to enable processor 610 to execute one or more applications, such as server applications, network communication processes, and any other type of application or software known to be available on computer systems. Alternatively, the instructions, application programs, etc. may be stored in an external storage or available from a memory over a network. The one or more storage devices may be a volatile or non-volatile, magnetic, semiconductor, tape, optical, removable, non-removable, or other type of storage device or tangible computer-readable medium.

In one embodiment, error message translation system 620 may include memory 630 that includes instructions that, when executed by processor 610, perform one or more processes consistent with the functionalities disclosed herein. Methods, systems, and articles of manufacture consistent with disclosed embodiments are not limited to separate programs or computers configured to perform dedicated tasks. For example, error message translation system 620 may include memory 630 that may include one or more programs 650 to perform one or more functions of the disclosed embodiments. Moreover, processor 610 may execute one or more programs 650 located remotely (see FIG. 7).

Memory 630 may include one or more memory devices that store data and instructions used to perform one or more features of the disclosed embodiments. Memory 630 may also include any combination of one or more databases controlled by memory controller devices (e.g., server(s), etc.) or software, such as document management systems, Microsoft™ SQL databases, SharePoint™ databases, Oracle™ databases, Sybase™ databases, or other relational or non-relational databases. Memory 630 may include software components that, when executed by processor 610, perform one or more processes consistent with the disclosed embodiments. In some embodiments, memory 630 may include a database 660 for storing related data to enable error message translation system 620 to perform one or more of the processes and functionalities associated with the disclosed embodiments.

Error message translation system 620 may also be communicatively connected to one or more memory devices (e.g., databases) locally or through a network. The remote memory devices may be configured to store information and may be accessed and/or managed by error message translation system 620. By way of example, the remote memory devices may be document management systems, Microsoft™ SQL database, SharePoint™ databases, Oracle™ databases, Sybase™ databases, or other relational or non-relational databases. Systems and methods consistent with disclosed embodiments, however, are not limited to separate databases or even to the use of a database.

Error message translation system 620 may also include one or more I/O devices 670 that may comprise one or more interfaces for receiving signals or input from devices and providing signals or output to one or more devices that allow data to be received and/or transmitted by error message translation system 620. For example, error message translation system 620 may include interface components, which may provide interfaces to one or more input devices, such as one or more keyboards, mouse devices, touch screens, track pads, trackballs, scroll wheels, digital cameras, microphones, sensors, and the like, that enable error message translation system 620 to receive data from one or more users.

In exemplary embodiments of the disclosed technology, error message translation system 620 may include any number of hardware and/or software applications that are executed to facilitate any of the operations. The one or more I/O interfaces may be utilized to receive or collect data and/or user instructions from a wide variety of input devices. Received data may be processed by one or more computer processors as desired in various implementations of the disclosed technology and/or stored in one or more memory devices.

FIG. 7 is an example block diagram of the system 700 that may be used to translate a stack trace and optionally redact or tokenize sensitive information found within the stack trace. The components and arrangements shown in FIG. 7 are not intended to limit the disclosed embodiments as the components used to implement the disclosed processes and features may vary. As system 700 may include a user device 702, an error message translation system 620, a third party server 730, and a third party database configured to communicate over a network 706. User device 702 and/or third party server 730 may have a similar structure as shown and described with respect to FIG. 6 and may include many components that are similar to or even have the same capabilities as those described with respect to error message translation system 620.

In some embodiments, the errore message translation system 620 may interact with (e.g., request/receive data from) a third party database 740 via a third party server 730 or without a third party server 730. In some embodiments, the third party server 730 may include a server and/or database (e.g., from a cloud storage provider). The third party database 740 may store, among other things, user classifications, stack traces, redacted stack traces, tokenized stack traces, text explanation of the stack traces, redacted stack traces, or tokenized stack traces. The error message translation system 620) may call the third party database 740 to retrieve the user classifications, stack traces, redacted stack traces, tokenized stack traces, text explanation of the stack traces, redacted stack traces, or tokenized stack trace. Sometimes, the third party server 730 is involved to handle the request for user classifications, stack traces, redacted stack traces, tokenized stack traces, text explanation of the stack traces, redacted stack traces, or tokenized stack trace from the third party database 740 and transmit the requested information (e.g., stack traces) to the error message translation system system 620).

In some embodiments, a customer may operate a user device 702. Although user device 702 is shown to be a laptop computer, user device 502 can each include a mobile device, smart phone, general purpose computer, tablet computer, laptop computer, telephone, PSTN landline, smart wearable device, other mobile computing device, or any other device capable of communicating with other devices (e.g., including those of access system 708) via network 706, or both. In some embodiments, user device 702 may include or incorporate electronic communication devices for hearing or vision impaired users. User device 702 may belong to or be provided by a user, or may be borrowed, rented, or shared. According to some embodiments, user devices 702 may include an environmental sensor for obtaining audio or visual data, such as a microphone and/or digital camera, a geographic location sensor for determining the location of the device, an input/output device such as a transceiver for sending and receiving data, a display for displaying digital images, one or more processors, and a memory in communication with the one or more processors.

Network 706 may be of any suitable type, including individual connections via the internet such as cellular or WiFi networks. In some embodiments, network 706 may connect terminals, services, and mobile devices including by using direct connections such as radio-frequency identification (RFID), near-field communication (NFC), Bluetooth™, low-energy Bluetooth™ (BLE), WiFi™, ZigBee™, ambient backscatter communications (ABC) protocols, USB, WAN, or LAN. Because the information transmitted may be personal or confidential, security concerns may dictate one or more of these types of connections be encrypted or otherwise secured. In some embodiments, however, the information being transmitted may be less personal, and therefore the network connections may be selected for convenience over security.

Network 706 may comprise any type of computer networking arrangement used to exchange data. For example, network 706 may be the Internet, a private data network, virtual private network using a public network, and/or other suitable connection(s) that enables components in system environment 700 to send and receive information between the components of system 700. Network 706 may also include a public switched telephone network (“PSTN”) and/or a wireless network.

Database 716 may be a database associated with access system 708 and may store a variety of information relating to users, transactions, user credentials (e.g., usernames and passwords), customer networks and devices, and business operations. Database 716 may also serve as a back-up storage device and may contain data and information that is also stored on, for example, local databases associated with web server 710, error message translation system 620. Database 716 may be accessed by other devices or systems (e.g., error message translation system 620) and may be used to store records of every interaction, communication, and/or transaction a particular user has had with access system 708.

While error message translation system 620 have been described as one form for implementing the techniques described herein, those having ordinary skill in the art will appreciate that other, functionally equivalent techniques may be employed. For example, as known in the art, some or all of the functionality implemented via executable instructions may also be implemented using firmware and/or hardware devices such as application specific integrated circuits (ASICs), programmable logic arrays, state machines, etc. Furthermore, other implementations of the error message translation system 620 may include a greater or lesser number of components than those illustrated.

Although the preceding description describes various functions of user device 702, database 716, and error message translation system 620, in some embodiments, some or all of these functions may be carried out by a single computing device.

### Exemplary Use Cases

The following exemplary use cases describe examples of a typical user flow pattern. They are intended solely for explanatory purposes and not in limitation.

In one exemplary use case, a user device 702 (or a third party server 730) may receive a first stack trace (e.g., an error message) or an error log containing a stack trace. The user device 702 may transmit the first stack trace along with a user classification (e.g., administrator, technician, user) of a requesting user to the error message translation system 620 over network 706. In some case, a third party server 730 may receive a request for the first stack trace from a user associated with user device 702 that includes the user classification. In this case, the third party server 730 passes along the first stack trace and the user classification. Regardless of the source, once the error message translation system 620 receives the first stack trace and the user classification, the error message translation system 620 may determine whether the received user classification corresponds to an administrator (e.g., the user classification is administrator or system administrator). When the error message translation system 620 determines that the user classification (e.g., user classification=user) does not correspond to the administrator, the error message translation system 620 may identify and redact, using a first trained neural network, sensitive information (e.g., social security numbers, account numbers, addresses, phone numbers, emails, health information, proprietary business information, privileged information) from the first stack trace to generate a first redacted stack trace. The error message translation system 620 may also encode the first redacted stack trace to generate a first embedding using a second trained neural network, decode the first embedding to generate a first text explanation corresponding to the first redacted stack trace by using a third trained neural network, decode the first embedding to generate a second redacted stack trace corresponding to the first redacted stack trace using a fourth trained neural network, and transmit the first text explanation and the second redacted stack trace to the first user device so that the first user device can display them allow the user to understand the second stack redacted stack trace without reading or disseminating sensitive information.

On the other hand, the error message translation system 620 may determine that the user classification (e.g., user classification=administrator) corresponds to the administrator, the error message translation system 620 may encode the second stack trace to generate a second embedding using the second trained neural network, decode the second embedding to generate a second text explanation corresponding to the first stack trace by using the third trained neural network, decode the second embedding to generate a fourth stack trace corresponding to the first stack trace using the fourth trained neural network, and transmit the second text explanation and the fourth stack trace to the first user device so that the first user device can display them.

To perform these various exemplary use cases, in some examples, the system may include one or more processors and a memory in communication with the one or more processors and storing instructions that when executed by the one or more processors, are configured to cause the system to perform steps of a method. The method may include receiving training data comprising a first stack trace, a first embedding of the first stack trace, a first text explanation corresponding to the first stack trace, a redacted first stack trace, a first embedding of the redacted first stack trace, a first redacted text explanation corresponding to the redacted first stack trace, and a first user classification, training a first neural network to identify and redact first sensitive information from the first stack trace to generate the redacted first stack trace depending on the first user classification by providing the first neural network with the first stack trace, the redacted first stack trace, and the first user classification, training a second neural network to encode the first stack trace or the redacted first stack trace depending on the first user classification by providing the second neural network with the redacted first stack trace, the first stack trace, the first embedding of the first stack trace, and the first embedding of the redacted first stack trace, training a third neural network to decode the first embedding of the first stack trace or the first embedding of the redacted first stack trace into the first text explanation corresponding to the first stack trace or the first redacted text explanation corresponding to the redacted first stack trace depending on the first user classification by providing the third neural network with the first embedding of the first stack trace, the first embedding of the redacted first stack trace, the first text explanation corresponding to the first stack trace, and the first text explanation corresponding to the redacted first stack trace, training a fourth neural network to decode the first embedding of the first stack trace or the first embedding of the redacted first stack trace to generate a new first stack trace corresponding to the first stack trace or a new redacted first stack trace corresponding to the first redacted stack trace depending on the first user classification by providing the fourth neural network with the first embedding of the redacted first stack trace, the first embedding of the first stack trace the redacted first stack trace, and the first stack trace. The method may also include receiving a second stack trace and a second user classification, determining whether the second user classification corresponds to an administrator. When the second user classification does not correspond to the administrator, the method may also include identifying and redacting, using the first neural network, second sensitive information from the second stack trace to generate a redacted second stack trace, encoding, using the second neural network, the redacted second stack trace to generate a second embedding, decoding, using the third neural network, the second embedding to generate a second text explanation corresponding to the redacted second stack trace, decoding, using the fourth neural network, the second embedding to generate a third stack trace corresponding to the redacted second stack trace, and transmitting, to a first user device for display, the second text explanation and the third stack trace.

When the second user classification corresponds to the administrator, the method may further include encoding, using the second neural network, the second stack trace to generate a third embedding, decoding, using the third neural network, the third embedding to generate a third text explanation corresponding to the second stack trace, decoding, using the fourth neural network, the third embedding to generate a fourth stack trace corresponding to the second stack trace, and transmitting, to the first user device for display, the third text explanation and the fourth stack trace.

In the method, the second stack trace and the second user classification may be received from the first user device.

In the method, the first neural network, the second neural network, and the third neural network, and the fourth neural network may each include an autoencoder, a generative adversarial network, a recurrent neural network, a non-recurrent neural network, a convolutional neural network, or a combination thereof.

In the method, the second neural network, the third neural network, and the fourth neural network may be autoencoders.

In the method, the first neural network, the second neural network, the third neural network, and the fourth neural network each may include long short-term memory, gated recurrent units, or both.

In the method, the first stack trace and the second stack trace may be from error logs.

The method may further include training the first neural network to determine whether the first user classification is the administrator.

In the method, the first neural network may determine whether the second user classification corresponds to the administrator.

To perform these various exemplary use cases, in some examples, the system may include one or more processors and a memory in communication with the one or more processors and storing instructions that when executed by the one or more processors, are configured to cause the system to perform steps of a method. The method may include receiving a first stack trace and a first user classification and determining whether the first user classification is an administrator. When the first user classification is not the administrator, the method may also include identifying and redacting, using a first neural network, first sensitive information from the first stack trace to generate a redacted first stack trace, encoding, using a second neural network, the redacted first stack trace to generate a first embedding, decoding, using a third neural network, the first embedding to generate a first text explanation corresponding to the redacted first stack trace, decoding, using a fourth neural network, the first embedding to generate a second stack trace corresponding to the redacted first stack trace, and transmitting, to a first user device for display, the first text explanation and the second stack trace.

When the first classification is the administrator, the method may also include encoding, using the second neural network, the first stack trace to generate a second embedding, decoding, using the third neural network, the second embedding to generate a second text explanation corresponding to the first stack trace, decoding, using the fourth neural network, the second embedding to generate a third stack trace corresponding to the first stack trace, and transmitting, to a first user device for display, the second text explanation and the third stack trace.

In the method, the first neural network may determine whether the first user classification is the administrator.

In the method, the first neural network, the second neural network, and the third neural network, and the fourth neural network each may include an autoencoder, a generative adversarial network, a recurrent neural network, a non-recurrent neural network, a convolutional neural network, or a combination thereof.

In the method, the second neural network, the third neural network, and the fourth neural network are autoencoders.

In the method, the first neural network, the second neural network, the third neural network, and the fourth neural network each comprise long short-term memory, gated recurrent units, or both.

To perform these various exemplary use cases, in some examples, the system may include one or more processors and a memory in communication with the one or more processors and storing instructions that when executed by the one or more processors, are configured to cause the system to perform steps of a method. The method may include receiving a first stack trace and a first user classification associated with a first user of a first user device, identifying, by a first neural network, sensitive information in the first stack trace, tokenizing, by the first neural network, the sensitive information in the first stack trace to generate a tokenized first stack trace, encoding, using a second neural network, the tokenized first stack trace to generate a first embedding, decoding, using a third neural network, the first embedding to generate a tokenized first text explanation corresponding to the tokenized first stack trace, decoding, using a fourth neural network, the first embedding to generate a tokenized second stack trace corresponding to the tokenized first stack trace, and determining whether the first user classification corresponds to an administrator. When the first user classification corresponds to the administrator, the method may also include detokenizing the tokenized second stack trace to generate a third stack trace, detokenizing the tokenized first text explanation to generate a second text explanation, and transmit, to the first user device for display, the third stack trace and the second text explanation.

When the first user classification does not correspond to the administrator, the method may also include transmitting, to the first user device for display, the tokenized first text explanation and the tokenized second stack trace.

In the method, the first stack trace and the first user classification may be received from the first user device.

In the method, the first neural network, the second neural network, and the third neural network, and the fourth neural network each may include an autoencoder, a generative adversarial network, a recurrent neural network, a non-recurrent neural network, a convolutional neural network, or a combination thereof.

In the method, the second neural network, the third neural network, and the fourth neural network may be autoencoders.

The features and other aspects and principles of the disclosed embodiments may be implemented in various environments. Such environments and related applications may be specifically constructed for performing the various processes and operations of the disclosed embodiments or they may include a general purpose computer or computing platform selectively activated or reconfigured by program code to provide the necessary functionality. Further, the processes disclosed herein may be implemented by a suitable combination of hardware, software, and/or firmware. For example, the disclosed embodiments may implement general purpose machines configured to execute software programs that perform processes consistent with the disclosed embodiments. Alternatively, the disclosed embodiments may implement a specialized apparatus or system configured to execute software programs that perform processes consistent with the disclosed embodiments. Furthermore, although some disclosed embodiments may be implemented by general purpose machines as computer processing instructions, all or a portion of the functionality of the disclosed embodiments may be implemented instead in dedicated electronics hardware.

The disclosed embodiments also relate to tangible and non-transitory computer readable media that include program instructions or program code that, when executed by one or more processors, perform one or more computer-implemented operations. The program instructions or program code may include specially designed and constructed instructions or code, and/or instructions and code well-known and available to those having ordinary skill in the computer software arts. For example, the disclosed embodiments may execute high level and/or low level software instructions, such as machine code (e.g., such as that produced by a compiler) and/or high level code that can be executed by a processor using an interpreter.

As used in this application, the terms “component,” “module,” “system,” “server,” “processor,” “memory,” and the like are intended to include one or more computer-related units, such as but not limited to hardware, firmware, a combination of hardware and software, software, or software in execution. For example, a component may be, but is not limited to being, a process running on a processor, an object, an executable, a thread of execution, a program, and/or a computer. By way of illustration, both an application running on a computing device and the computing device can be a component. One or more components can reside within a process and/or thread of execution and a component may be localized on one computer and/or distributed between two or more computers. In addition, these components can execute from various computer readable media having various data structures stored thereon. The components may communicate by way of local and/or remote processes such as in accordance with a signal having one or more data packets, such as data from one component interacting with another component in a local system, distributed system, and/or across a network such as the Internet with other systems by way of the signal.

Certain embodiments and implementations of the disclosed technology are described above with reference to block and flow diagrams of systems and methods and/or computer program products according to example embodiments or implementations of the disclosed technology. It will be understood that one or more blocks of the block diagrams and flow diagrams, and combinations of blocks in the block diagrams and flow diagrams, respectively, can be implemented by computer-executable program instructions. Likewise, some blocks of the block diagrams and flow diagrams may not necessarily need to be performed in the order presented, may be repeated, or may not necessarily need to be performed at all, according to some embodiments or implementations of the disclosed technology.

These computer-executable program instructions may be loaded onto a general-purpose computer, a special-purpose computer, a processor, or other programmable data processing apparatus to produce a particular machine, such that the instructions that execute on the computer, processor, or other programmable data processing apparatus create means for implementing one or more functions specified in the flow diagram block or blocks. These computer program instructions may also be stored in a computer-readable memory that can direct a computer or other programmable data processing apparatus to function in a particular manner, such that the instructions stored in the computer-readable memory produce an article of manufacture including instruction means that implement one or more functions specified in the flow diagram block or blocks.

As an example, embodiments or implementations of the disclosed technology may provide for a computer program product, including a computer-usable medium having a computer-readable program code or program instructions embodied therein, said computer-readable program code adapted to be executed to implement one or more functions specified in the flow diagram block or blocks. Likewise, the computer program instructions may be loaded onto a computer or other programmable data processing apparatus to cause a series of operational elements or steps to be performed on the computer or other programmable apparatus to produce a computer-implemented process such that the instructions that execute on the computer or other programmable apparatus provide elements or steps for implementing the functions specified in the flow diagram block or blocks.

Accordingly, blocks of the block diagrams and flow diagrams support combinations of means for performing the specified functions, combinations of elements or steps for performing the specified functions, and program instruction means for performing the specified functions. It will also be understood that each block of the block diagrams and flow diagrams, and combinations of blocks in the block diagrams and flow diagrams, can be implemented by special-purpose, hardware-based computer systems that perform the specified functions, elements or steps, or combinations of special-purpose hardware and computer instructions.

Certain implementations of the disclosed technology are described above with reference to user devices may include mobile computing devices. Those skilled in the art recognize that there are several categories of mobile devices, generally known as portable computing devices that can run on batteries but are not usually classified as laptops. For example, mobile devices can include, but are not limited to portable computers, tablet PCs, internet tablets, PDAs, ultra-mobile PCs (UMPCs), wearable devices, and smart phones. Additionally, implementations of the disclosed technology can be utilized with internet of things (IoT) devices, smart televisions and media devices, appliances, automobiles, toys, and voice command devices, along with peripherals that interface with these devices.

In this description, numerous specific details have been set forth. It is to be understood, however, that implementations of the disclosed technology may be practiced without these specific details. In other instances, well-known methods, structures and techniques have not been shown in detail in order not to obscure an understanding of this description. References to “one embodiment,” “an embodiment,” “some embodiments,” “example embodiment,” “various embodiments,” “one implementation,” “an implementation,” “example implementation,” “various implementations,” “some implementations,” etc., indicate that the implementation(s) of the disclosed technology so described may include a particular feature, structure, or characteristic, but not every implementation necessarily includes the particular feature, structure, or characteristic. Further, repeated use of the phrase “in one implementation” does not necessarily refer to the same implementation, although it may.

Throughout the specification and the claims, the following terms take at least the meanings explicitly associated herein, unless the context clearly dictates otherwise. The term “or” is intended to mean an inclusive “or.” Further, the terms “a,” “an,” and “the” are intended to mean one or more unless specified otherwise or clear from the context to be directed to a singular form. By “comprising” or “containing” or “including” is meant that at least the named element, or method step is present in article or method, but does not exclude the presence of other elements or method steps, even if the other such elements or method steps have the same function as what is named.

While certain embodiments of this disclosure have been described in connection with what is presently considered to be the most practical and various embodiments, it is to be understood that this disclosure is not to be limited to the disclosed embodiments, but on the contrary, is intended to cover various modifications and equivalent arrangements included within the scope of the appended claims. Although specific terms are employed herein, they are used in a generic and descriptive sense only and not for purposes of limitation.

This written description uses examples to disclose certain embodiments of the technology and also to enable any person skilled in the art to practice certain embodiments of this technology, including making and using any apparatuses or systems and performing any incorporated methods. The patentable scope of certain embodiments of the technology is defined in the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A system, comprising:
one or more processors; and
a memory in communication with the one or more processors and storing instructions that, when executed by the one or more processors, are configured to cause the system to:
receive training data comprising a first stack trace, a first embedding of the first stack trace, a first text explanation corresponding to the first stack trace, a redacted first stack trace, a first embedding of the redacted first stack trace, a first redacted text explanation corresponding to the redacted first stack trace, and a first user classification;
train a first neural network to identify and redact first sensitive information from the first stack trace to generate the redacted first stack trace depending on the first user classification by providing the first neural network with the first stack trace, the redacted first stack trace, and the first user classification;
train a second neural network to encode the first stack trace or the redacted first stack trace depending on the first user classification by providing the second neural network with the redacted first stack trace, the first stack trace, the first embedding of the first stack trace, and the first embedding of the redacted first stack trace;
train a third neural network to decode the first embedding of the first stack trace or the first embedding of the redacted first stack trace into the first text explanation corresponding to the first stack trace or the first redacted text explanation corresponding to the redacted first stack trace depending on the first user classification by providing the third neural network with the first embedding of the first stack trace, the first embedding of the redacted first stack trace, the first text explanation corresponding to the first stack trace, and the first text explanation corresponding to the redacted first stack trace;
train a fourth neural network to decode the first embedding of the first stack trace or the first embedding of the redacted first stack trace to generate a new first stack trace corresponding to the first stack trace or a new redacted first stack trace corresponding to the first redacted stack trace depending on the first user classification by providing the fourth neural network with the first embedding of the redacted first stack trace, the first embedding of the first stack trace the redacted first stack trace, and the first stack trace;
receive a second stack trace and a second user classification;
determine whether the second user classification corresponds to an administrator;
when the second user classification does not correspond to the administrator:
identify and redact, using the first neural network, second sensitive information from the second stack trace to generate a redacted second stack trace;
encode, using the second neural network, the redacted second stack trace to generate a second embedding;
decode, using the third neural network, the second embedding to generate a second text explanation corresponding to the redacted second stack trace;
decode, using the fourth neural network, the second embedding to generate a third stack trace corresponding to the redacted second stack trace; and
transmit, to a first user device for display, the second text explanation and the third stack trace.

2. The system of claim 1, wherein the memory stores further instructions that, when executed by the one or more processors, are further configured to cause the system to:
when the second user classification corresponds to the administrator:
encode, using the second neural network, the second stack trace to generate a third embedding;
decode, using the third neural network, the third embedding to generate a third text explanation corresponding to the second stack trace;
decode, using the fourth neural network, the third embedding to generate a fourth stack trace corresponding to the second stack trace; and
transmit, to the first user device for display, the third text explanation and the fourth stack trace.

3. The system of claim 2, wherein the second stack trace and the second user classification are received from the first user device.

4. The system of claim 2, wherein the second neural network, and the third neural network, and the fourth neural network each comprise an autoencoder, a generative adversarial network, a recurrent neural network, a non-recurrent neural network, a convolutional neural network, or a combination thereof, and
wherein the first neural network comprises a named entity recognition system.

5. The system of claim 2, wherein the second neural network, the third neural network, and the fourth neural network are autoencoders.

6. The system of claim 2, wherein the first neural network, the second neural network, the third neural network, and the fourth neural network each comprise long short-term memory, gated recurrent units, or both.

7. The system of claim 2, wherein the first stack trace and the second stack trace are from error logs.

8. The system of claim 2, wherein the memory stores further instructions that, when executed by the one or more processors, are further configured to cause the system to train the first neural network to determine whether the first user classification is the administrator.

9. The system of claim 8, wherein the first neural network determines whether the second user classification corresponds to the administrator.

10. A system, comprising:
one or more processors; and
a memory in communication with the one or more processors and storing instructions that, when executed by the one or more processors, are configured to cause the system to:
receive a first stack trace and a first user classification;
determine whether the first user classification is an administrator;
when the first user classification is not the administrator:
identify and redact, using a first neural network, first sensitive information from the first stack trace to generate a redacted first stack trace;
encode, using a second neural network, the redacted first stack trace to generate a first embedding;
decode, using a third neural network, the first embedding to generate a first text explanation corresponding to the redacted first stack trace;
decode, using a fourth neural network, the first embedding to generate a second stack trace corresponding to the redacted first stack trace; and
transmit, to a first user device for display, the first text explanation and the second stack trace.

11. The system of claim 10, wherein the memory stores further instructions that, when executed by the one or more processors, are further configured to cause the system to:
when the first user classification is the administrator:
encode, using the second neural network, the first stack trace to generate a second embedding;
decode, using the third neural network, the second embedding to generate a second text explanation corresponding to the first stack trace;
decode, using the fourth neural network, the second embedding to generate a third stack trace corresponding to the first stack trace; and
transmit, to a first user device for display, the second text explanation and the third stack trace.

12. The system of claim 11, wherein the first neural network comprises a named entity recognition system.

13. The system of claim 12, wherein the second neural network, and the third neural network, and the fourth neural network each comprise an autoencoder, a generative adversarial network, a recurrent neural network, a non-recurrent neural network, a convolutional neural network, or a combination thereof.

14. The system of claim 11, wherein the second neural network, the third neural network, and the fourth neural network are autoencoders.

15. The system of claim 11, wherein the first neural network, the second neural network, the third neural network, and the fourth neural network each comprise long short-term memory, gated recurrent units, or both.

16. A system, comprising:
one or more processors; and
a memory in communication with the one or more processors and storing instructions that, when executed by the one or more processors, are configured to cause the system to:
receive a first stack trace and a first user classification associated with a first user of a first user device;
identify, by a first neural network, sensitive information in the first stack trace;
tokenize, by the first neural network, the sensitive information in the first stack trace to generate a tokenized first stack trace;
encode, using a second neural network, the tokenized first stack trace to generate a first embedding;
decode, using a third neural network, the first embedding to generate a tokenized first text explanation corresponding to the tokenized first stack trace;
decode, using a fourth neural network, the first embedding to generate a tokenized second stack trace corresponding to the tokenized first stack trace;
determine whether the first user classification corresponds to an administrator; and
when the first user classification corresponds to the administrator, detokenize the tokenized second stack trace to generate a third stack trace, detokenize the tokenized first text explanation to generate a second text explanation, and transmit, to the first user device for display, the third stack trace and the second text explanation.

17. The system of claim 16, wherein the memory stores further instructions that, when executed by the one or more processors, are further configured to cause the system to:
when the first user classification does not correspond to the administrator, transmit, to the first user device for display, the tokenized first text explanation and the tokenized second stack trace.

18. The system of claim 17, wherein the first stack trace and the first user classification are received from the first user device.

19. The system of claim 17, wherein the first neural network comprises a named entity recognition system, and wherein the second neural network, and the third neural network, and the fourth neural network each comprise an autoencoder, a generative adversarial network, a recurrent neural network, a non-recurrent neural network, a convolutional neural network, or a combination thereof.

20. The system of claim 17, wherein the second neural network, the third neural network, and the fourth neural network are autoencoders.
